(19) United States
(12) Patent Application Publication
(10) Pub. No.: US 2007/0107731 A1
(43) Pub. Date: May 17, 2007

(54) Clip-in nostril expander

(76) Inventor: Glen B. Reed, St. George, UT (US)

Correspondence Address: M. REID RUSSELL, 854 WEST 3390 SOUTH, HURRICANE, UT, 84737, US

(21) Appl. No.: 11/273,412

(22) Filed: Nov. 15, 2005

(51) Int. Cl. A62B 7/10

(52) U.S. Cl. 128/206.11

(57) ABSTRACT

A clip-in nostril expander including a pair of like short cylindrical dilators that are each formed from a soft plastic material for insertion into each of a person's nostrils, opening each nostril to a free flow of air. The dilators each attach to one of opposite ends of a strap formed from a material to retain a bend, or includes an insert encapsulated therein, to maintain a bend formed therein as by a person who bends the strap at a mid-point and, with the bend held between their thumb and forefinger, inserts each of the dilators into each of their nostrils, clamping the strap at its bend to the person's septum, holding the dilators in the person's nostrils.

### BACKGROUND OF THE INVENTION

1. Field of the Invention

The present invention pertains to devices for inserting into each nostril of a human's nose to hold open the breathing passages thereof.

2. Prior Art

Currently, there are a number of breathing aids on the market for opening a person's nasal passages. One such device is a band aid type device for positioning across a person's nose to hold open the nostrils at their outer walls, and an example of this type of device is shown in a Johnson U.S. Pat. Nos. 5,549,103 and 5,653,224. Further, and more similar to the present invention, U.S. patents to Caballero, U.S. Pat. No. 3,710,799; to Rella, U.S. Pat. No. 4,105,035; to Rezakhany, U.S. Pat. No. 4,414,977; to Lee, U.S. Pat. No. 5,665,104; and to Filis, U.S. Pat. No. 6,004,342, show devices for fitting into a person's nostrils. Like the invention, the Lee U.S. Pat. No. 5,665,104 and Filis U.S. Pat. No. 6,004,342 patents both show a pair of cylinders connected by a strap, with each cylinder for fitting into a person's nostril. Where the Filis '342 patent shows the inserts as truncated cylinders that attempt to conform to the shape of a person's nasal cavities, the Lee '104 patent, like the invention, shows the cylinders as being regular cylinders. Distinct from both the Filis and Lee patents, as well as the other cited patents, the invention does not rely on the shape or diameter of the cylinders to maintain the positioning of the individual cylinders in the person's nostrils. Rather, the strap connecting the cylinders of the invention is formed to bend and retain that bend, clamping onto the surface of the septum between the person's nostrils. Which strap, to remove the invention, is easily bent out of clamping engagement, and is gripped between the person's thumb and fore finger to pull the cylinders out of the person's nostrils.

### SUMMARY OF THE INVENTION

The invention relates to devices for improving air flow through a person's nasal passages. The invention includes a pair of like short cylindrical shaped dilators that are of a diameter that is selected to comfortable fit into each of the person's nasal cavities and includes a strap connected at its ends to the short cylinders lower edges, to span the septum. With the short cylinders fitting comfortably in the person's nasal passages, the strap, that is formed from a thermoplastic elastomer material to hold a fold therein or contains a section of material implanted therein to hold a fold, is pinched to clip to the person's septum, holding the short cylinders in place. Which pair of short cylinders are preferably formed from a flexible plastic material, such as a thermoplastic elastomer, that will not react with the skin of the septum and a thermoplastic elastomer material Santoprene manufactured by Exon Mobile has been used for this application. It should, however be understood, that the material from which the invention is formed can be any suitable material and the strap may or may not include an insert, such as a wire, implanted therein to allow it to retain a fold or bend therein for clamping to and across the person's septum, within the scope of this disclosure.

It is a principal object of the present invention to provide a device for improving the air flow through a person's nasal passages.

Another object of the present invention is to provide a device that is easily installed and comfortably worn in a person's nostrils during the day and/or night for improving an air flow through their nasal passages.

Still another object of the present invention is to provide a device for comfortably keeping a person's nasal passages open during the day and night.

### BRIEF DESCRIPTION OF THE DRAWINGS

These and other objects and features of the present invention will become more apparent from the following description in which the invention is described in detail in conjunction with the accompanying drawings:

FIG. 1 is a side elevation perspective view of the invention in a clip-in nasal expander that includes a pair of like short cylinders that each connect to an end of a single strap;

FIG. 2 is a front elevation view of the clip-in nasal expander of FIG. 1 showing, with curved arrow A, the strap as being bent upon itself at its center;

FIG. 3 shows a front elevation view of the clip-in nasal expander held at the strap bend between a person's thumb and forefinger, with the short cylinders aligned for insertion into the person's nostrils; and

FIG. 4 shows a bottom plan view of the person's nose and nostrils of FIG. 3, showing the cylinders installed in the person's nostrils and with the strap clamped onto the person's septum.

### DETAILED DESCRIPTION

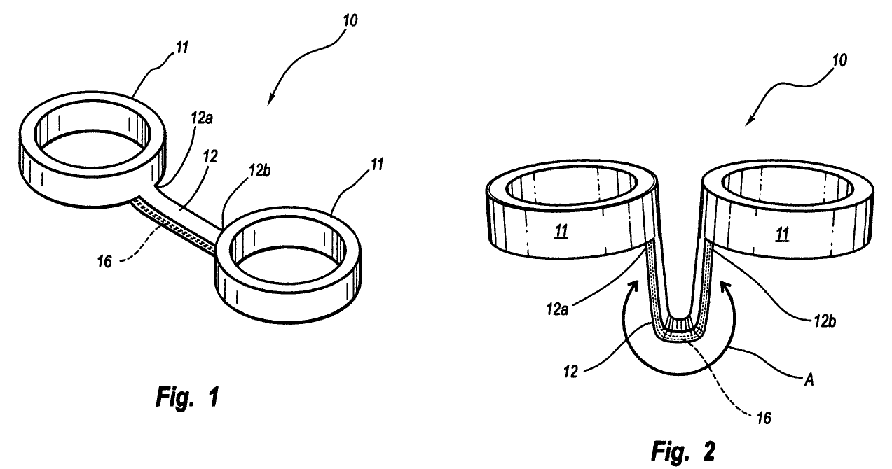

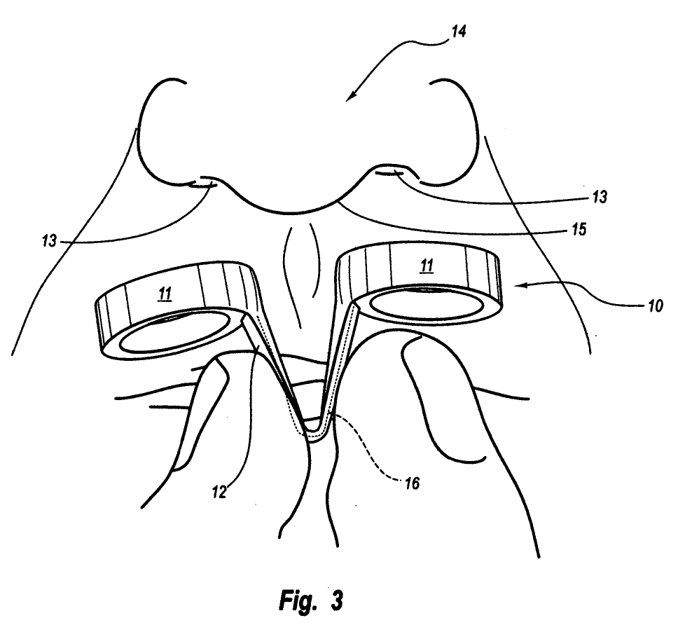

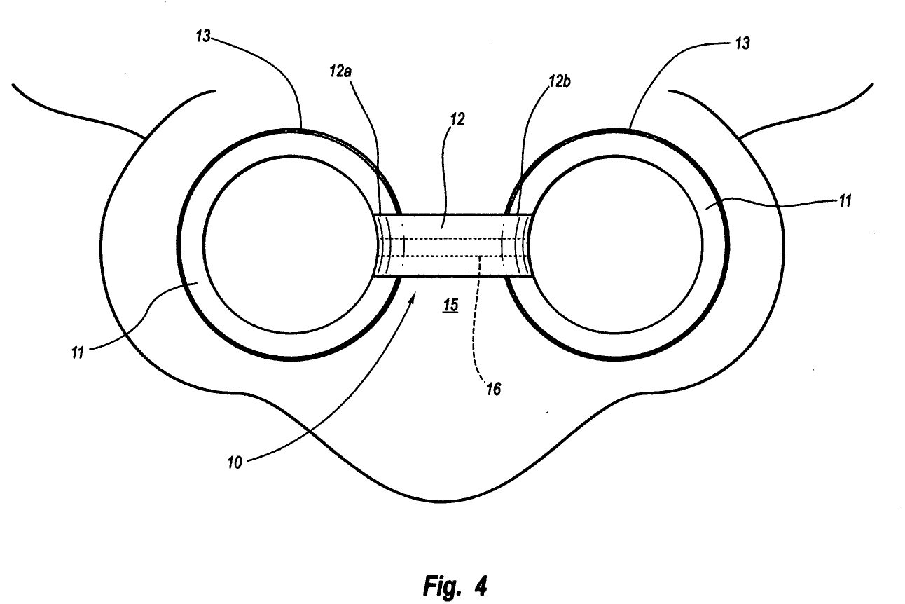

The invention, as is hereinafter described, is in a device for wear by a person during the day or night to provide for opening the nasal cavities 13 of nose 14. FIG. 1 shows a clip-in nostril expander 10 of the invention as including a pair of like size identical short cylindrical shaped dilators 11 that are each connected at 12a to ends of a strap 12. The dilators 11 are preferably formed from a soft non-reactive plastic material, such as a thermoplastic elastomer known as Santoprene manufactured by Exon Mobile has been used that will conform to the person's nasal cavities 13, fitting snugly and comfortably therein. For maintaining the dilators 11 in the person's nasal cavities, at their nostril ends, the strap 12, as shown in FIGS. 2 and best in FIG. 3, is arranged to be bent, as shown by arrow A in FIG. 2, to be fitted to, in clamping engagement, across the person's septum 15, as illustrated in FIGS. 3 and 4. To provide which bending of the strap 12 at its center, as shown in FIG. 3, and its holding that center bend to provide a clamping action onto the person's septum 15, as shown in FIG. 4, the strap 12 is formed from a bendable material that, after bending pressure is removed, the strap will retain the bend, as shown in FIG. 4. So arranged, the dilators 11 are comfortably fitted into the person's nostrils and are maintained therein by the operation of the strap that, once closed across the septum 15, will continue to clamp thereto. A selected thermoplastic elastomer has been found to have the memory characteristics required to provide the strap 12 with the required clamping ability. Additionally, to further enhance the clamping ability of the strap 12, a bendable wire or flat section 16, shown in broken lines in FIGS. 1, 3 and 4, can be encapsulated in the strap. Which wire or flat section 16 can be formed from aluminum, copper, or other metal that will retain the strap in its bent attitude, shown in FIGS. 2 and 3, to clip across the septum 15, and is easily spread apart to allow for removal of the clip-in nostril expander 10.

With the positioning of the clip-in nostril expander dilators 11 in a person's nostrils, breathing takes place through the dilators 11, greatly lessening the exertion that was formerly necessary to pass air in and out of the nose, without a necessity of undergoing a surgical procedure as has often been prescribed for breathing problems. In practice, problems with snoring have often been cured with a first overnight installation of the device, and persons have uniformly reported improvements in breathing with little or no discomfort.

Hereinabove has been set out a description of a preferred embodiment of the clip-in nostril expander of the invention. It should however, be understood that the present invention can be varied within the scope of this disclosure without departing from the subject matter coming within the scope of the following claims, and a reasonable equivalency thereof, which claims I regard as my invention.

1. A clip-in nostril expander comprising, a pair of separate like dilators that are each formed from an elastomeric material to have a cylindrical shape and a diameter to comfortably fit in each of a person's nostrils; and a strap that is connected at its ends to each of said dilators and is formed from an elastomeric material that has a capability to retain a bend formed there and provide for clamping across the skin of a person's septum between their nostrils.

2. The clip-in nostril expander as recited in claim 1, further including a means arranged with the strap for maintaining said strap in a bent attitude.

3. The clip-in nostril expander as recited in claim 2, wherein the means for maintaining the strap in a bent attitude is a section of a wire that is encapsulated in said strap that, when bent, retains its bent attitude

4. The clip-in nostril expander as recited in claim 3, wherein the wire is a section of aluminum or copper wire.

5. The clip-in nostril expander as recited in claim 2, wherein the means for maintaining the strap in a bent attitude is a flat section of a metal having a thickness of from one sixteenth ( 1/16) to one sixty fourth ( 1/64) of an inch that is encapsulated in said strap and, when bent, retains said bend.

6. The clip-in nostril expander as recited in claim 1, wherein the clip-in nostril expander is formed from a thermoplastic elastomer.
